(19) United States
(12) Patent Application Publication
(10) Pub. No.: US 2013/0270810 A1
(43) Pub. Date: Oct. 17, 2013

(54) Print Process and System to Prevent Identification of Press Repeat

(71) Applicant: Michael Ross, Valparaiso, IN (US)

(72) Inventor: Michael Ross, Valparaiso, IN (US)

(21) Appl. No.: 13/994,169

(22) PCT Filed: Dec. 5, 2011
(86) PCT No.: PCT/US11/63241

§ 371 Date: Jun. 14, 2013

Related U.S. Application Data
(60) Provisional application No. 61/426,696, filed on Dec. 23, 2010.

(51) Int. Cl. B41F 17/26; B42D 15/00

(52) U.S. Cl. CPC B41F 17/26; B42D 15/00
USPC 283/62; 101/483; 101/219

(57) ABSTRACT

A process for making a decorative sheet material includes applying a first printed pattern to a web as the web travels over a first printing cylinder having a first diameter, and applying a second printed pattern to the web as the web travels over a second printing cylinder having a second diameter, which is different than the first diameter. A system for making a decorative sheet material includes a first printing cylinder for applying a first printed pattern on a web travelling over the first printing cylinder, and a second printing cylinder for applying a second printed pattern on the web travelling over the second printing cylinder. The first printing cylinder has a first diameter. The second printing cylinder has a second diameter, which is different than the first diameter.

### CROSS-REFERENCE TO RELATED APPLICATION

The present application claims the benefit of U.S. Provisional Patent Application No. 61/426,696 filed Dec. 23, 2010, which is incorporated herein by reference in its entirety.

### BACKGROUND OF THE INVENTION

The subject disclosure relates generally to printing systems and methods for applying a pattern to a web to produce a decorative sheet material.

Decorative sheet materials can be used to apply a wood grain pattern to a substrate such as exterior siding panels and related outdoor construction products, as well as other manufactured goods. A known process to apply a decorative pattern to the web includes passing the web through a series of gravure print stations and ovens in tandem where the printed pattern is applied to a surface of the web. Each gravure station includes a printing cylinder, and in this known system each printing cylinder for each print station has the same diameter and rotates at the same rate of rotation or revolutions per minute (“RPM”). Some manufacturers step the diameter of presses around 0.0005″, however, each printing cylinder for each print station, even in the stepped arrangement, essentially still has the same diameter and rotates at essentially the same RPM. This ensures that the web travels through the system from a supply roll to a take-up roll without any slack between the print stations.

Since each printing cylinder has the same diameter and rotates at the same RPM, the final print pattern that is applied to the web repeats in a machine direction. On larger items, to which the printed web is applied to provide the decorative print pattern, the repeated pattern can be noticeable to an observer. A clean looking repeated pattern can provide a very attractive looking product. However, where the printed pattern is a wood grain or other pattern that does not lend itself well to a noticeably repeatable pattern, the noticeable repeat of the pattern can result in the item appearing less attractive or being considered a less desirable imitation or “fake.”

### SUMMARY OF THE INVENTION

An example of a process for making a decorative sheet material that can overcome at least one of the aforementioned shortcomings includes applying a first printed pattern to a web as the web travels over a first printing cylinder having a first diameter, and applying a second printed pattern to the web as the web travels over a second printing cylinder having a second diameter, which is different than the first diameter. When making decorative sheet materials with the aforementioned process, the first printed pattern on the web and the second printed pattern on the web appear as one finished printed pattern on the decorative sheet material. Identification of the repeating nature of the finished printed pattern, however, is not readily apparent to an ordinary observer. This results in the product to which the printed pattern is applied looking more attractive and/or more authentic.

A system for making a decorative sheet material that can overcome at least one of the aforementioned shortcomings includes a first printing cylinder for applying a first printed pattern on a web travelling over the first printing cylinder, and a second printing cylinder for applying a second printed pattern on the web travelling over the second printing cylinder. The first printing cylinder has a first diameter. The second printing cylinder has a second diameter, which is different than the first diameter. Decorative sheet materials made using the aforementioned system can also provide a more natural or authentic-looking printed pattern that does not repeat in the manner described above.

A decorative sheet material that can overcome at least one of the aforementioned shortcomings includes a web, a first printed pattern on the web, and a second printed pattern on the web. The first printed pattern includes prominent first printed markings and other first printed markings. Each prominent first printed marking is evenly spaced from adjacent prominent first printed markings in a machine direction. The second printed pattern includes prominent second printed markings and other second printed markings. Each prominent second printed marking is unevenly spaced from adjacent prominent first printed markings in the machine direction. An article including the decorative sheet material is disclosed, as well as a decorative sheet material manufactured in accordance with the aforementioned process.

### BRIEF DESCRIPTION OF THE DRAWINGS

FIG. 1 is a schematic depiction of a system for making a decorative sheet material.

FIG. 2 depicts an article having a wood grain pattern applied thereto.

FIG. 3 is a flow diagram of a process for making a decorative sheet material.

### DETAILED DESCRIPTION OF THE INVENTION

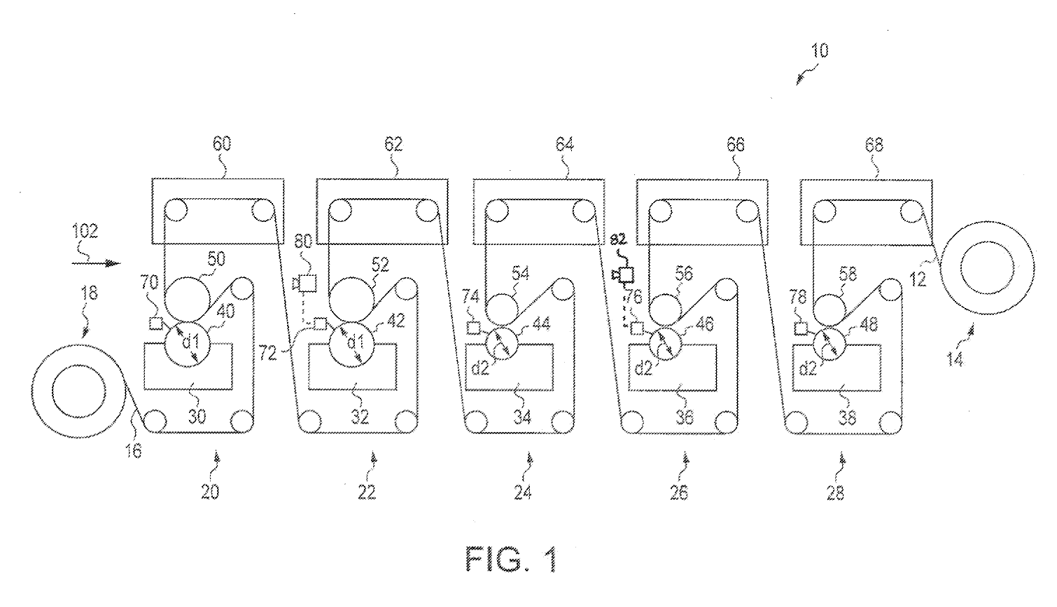

FIG. 1 schematically depicts a system 10 for making a decorative sheet material 12, which is being taken up on a take-up roll 14. In the depicted system 10, a web 16 from a supply roll 18 travels over idler rolls to a series of print stations 20, 22, 24, 26, 28, which could be gravure print stations or flexographic print stations. Five print stations 20, 22, 24, 26, 28 are depicted, however, a fewer or a greater number of print stations can be employed. The system 10 is useful to manufacture the decorative sheet material 12 to have a final printed pattern where identification of where the final printed pattern repeats itself is difficult to ascertain. The final printed pattern can be visible as an observer looks through a clear substrate, which can be the web 16.

With continued reference to the embodiment depicted in FIG. 1, each print station includes a respective ink trough 30, 32, 34, 36, 38. Each print station also includes a respective printing cylinder 40, 42, 44, 46, 48 that picks up ink from the respective ink trough 30, 32, 34, 36, 38. Excess ink is metered off using a doctor blade (not shown). Each print station 20, 22, 24, 26, 28 also includes a respective impression cylinder 50, 52, 54, 56, 58. The web 16 travels between the respective printing cylinders 40, 42, 44, 46, 48 and the respective impression cylinders 50, 52, 54, 56, 58 to apply a desired image, i.e., the final printed pattern, onto the web 16 to prepare the decorative sheet material 12. Each print station 20, 22, 24, 26, 28 is also associated with a respective oven 60, 62, 64, 66, 68 for drying the web 16 between respective print stations.

A drive system rotates the respective printing cylinders 40, 42, 44, 46, 48. As illustrated, each print station 20, 22, 24, 26, 28 includes a respective drive unit 70, 72, 74, 76, 78. As illustrated, the drive system can be part of an electronic line shaft and each respective drive unit 70, 72, 74, 76, 78 can include and/or communicate with sensors to detect the tension of the web 16 travelling through the respective print station and adjust the rotational speed, i.e., RPM, of the respective printing cylinders 40, 42, 44, 46, 48 to take up any slack in the web 16 as the web travels through the printing system 10. Alternatively, the printing system 10 could employ a mechanical line shaft, where one drive unit would be employed to rotate each of the printing cylinders 40, 42, 44, 46, 48. Since some of the printing cylinders will be rotating at different RPMs with respect to one another, where a mechanical line shaft is employed, clutches and reduction gears may need to be located on the mechanical line shaft to allow for the rotation at different RPMs.

The illustrated system 10 also includes a registration unit 80. The registration unit 80 is schematically depicted and can include a camera, or other detection device, that detects a registration marking on the web 16 as the web travels between the first print station 20 and the second print station 22. The registration unit 80 communicates with the drive unit 72 and/or the drive unit 70 to maintain register between the first print station 20 and the second print station 22. Further registration units can be employed if desired.

With reference to the particular embodiment depicted in FIG. 1, the first print station 20 and the third print station 24 are configured to apply what will be referred to as a first printed pattern and a second printed pattern, respectively, to the web 16 travelling through the system 10. The second print station 22, the fourth print station 26, and the fifth print station 28 are each configured to apply color to the web 16. For example, where the printing system 10 is configured to apply a wood grain pattern on the web 16, the first print station 20 and the third print station 24 can each apply different line sections of the final wood grain pattern to the web 16. These line sections denote the annual growth rings and/or knots found in natural wood. The second print station 22, the fourth print station 26 and the fifth print station 28 can apply color to the web to result in the final wood grain pattern on the decorative sheet material 12. More particularly, the second print station 22 and the fourth print station 26 can apply a color print to the web that can add depth and highlight the print patterns applied at the first print station 20 and the third print station 24, respectively. This color, which adds depth to the final printed image, provides a more realistic and attractive printed design, and more print stations can be added, if desired, to best produce the intended design. The fifth print station 28 can color coat the web 16 to provide a background color for the final printed design.

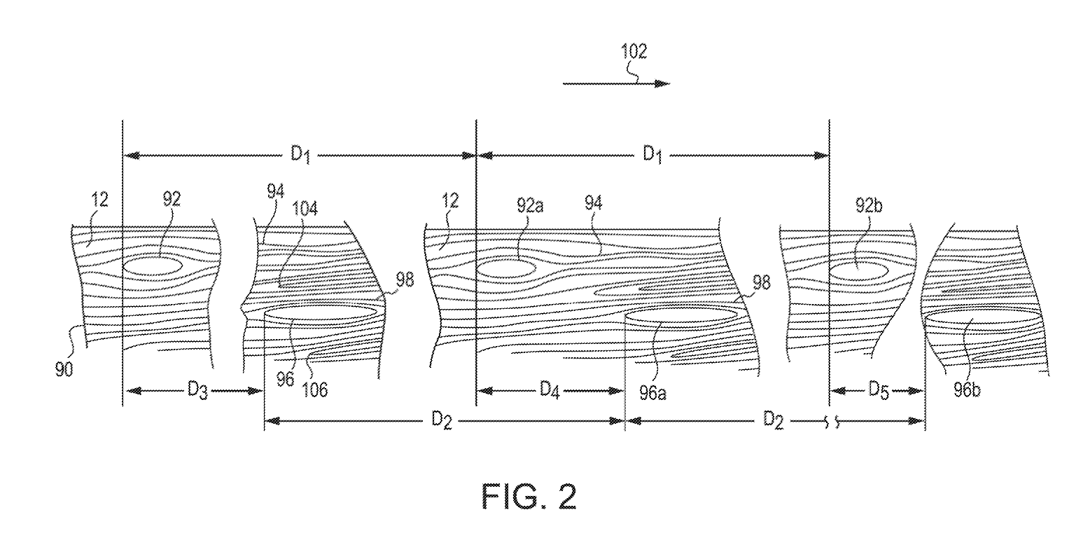

The system 10 includes the first printing cylinder 40 for applying the first printed pattern on the web 16 as the web travels over the first printing cylinder. The system 10 also includes a second printing cylinder 44 for applying the second printed pattern on the web as the web travels over the second printing cylinder. The first printing cylinder 40 has a first diameter d₁. The second printing cylinder 44 has a second diameter d₂, which is different than the first diameter d₁. As illustrated, d₁ is greater than d₂; however, d₁ could be less than d₂. By providing printing cylinders having different diameters, a noticeable repeat of the wood grain pattern is much less likely to occur, which provides an article 90 (FIG. 2) having a synthetic wood grain finish appearing to an observer to have a more authentic wood grain pattern.

With reference to FIG. 2 the article 90 is shown having a final wood grain pattern from the decorative sheet material 12 applied thereto. Only a portion of the article 12 and the corresponding decorative sheet material 12 is shown in FIG. 2. The article could be any material to which the pattern from the decorative sheet material could be applied, examples of which include exterior siding panels and related outdoor construction products. The first printing cylinder 40 (FIG. 1) is configured such that for each rotation, the first printing cylinder prints a first printed pattern having at least one prominent first printed marking 92 and other first printed markings 94. As seen in FIG. 2, the prominent first printed marking 92 is more prominent than other first printed markings 94 on the web. After the prominent first printed marking 92 and the other first printed markings 94 are applied to the web 16 at the first print station 20, the web then travels to the second print station 22, which will be described below, and then to the third print station 24, which includes the second printing cylinder 44. The second printing cylinder 44 is configured such that for each rotation, the second printing cylinder prints the second printed pattern having at least one prominent second printed marking 96 and other second printed markings 98. As seen in FIG. 2, the prominent second printed marking 96 is more prominent than the other second printed markings 98 on the web.

The prominent markings 92 and/or 96 are more prominent than the other printed markings 94 and/or 98 in that the prominent markings are more easily detected by an observer as compared to the other printed markings 94 and 98. For example, the prominent markings could be a different shape than the other printed markings. As another example, the prominent markings could be a different color than the other printed markings. As yet another example, the prominent markings could be a much larger or much smaller shape (e.g., two, three or even more times larger or smaller) than the other printed markings.

FIG. 2 depicts a wood grain printed pattern and each of the prominent markings 92, 92a, 92b and 96, 96a, 96b as ring shaped markings in the wood grain. Each prominent marking can also denote knots in the wood grain, as well as other easily recognizable features, such as where the wood grain meets at a relatively tighter vertex, depicted as vertexes 104 and 106 in FIG. 2, as compared to the other less prominent markings, e.g., markings 94 and 98, on the wood grain pattern. The first printing cylinder 40 is configured to rotate to apply the first printed pattern having equally spaced prominent first printed markings 92 along a machine direction 102 of the web, e.g., each prominent first printed marking 92, 92a, 92b is spaced D₁ from an adjacent prominent first printed marking. The distance D₁ between adjacent prominent first printed markings is a function of the circumference of the first printing cylinder 40. As such, if only one printing cylinder were employed, the prominent markings in the wood grain, as denoted by the first printed markings 92 and 104, would be equally spaced from one another along the machine direction 102, and thus the repeat pattern of the wood grain pattern could be noticeable to an observer viewing the article 90. A noticeably repeating wood grain pattern can be found undesirable. This is more likely to occur on larger articles, such as construction articles like garage doors, flooring, siding, and the like.

With the illustrated system 10, however, the second printing cylinder 44 is configured to rotate to apply the second printed pattern having unequal spacing between prominent second printed markings 96, 96a, 96b and adjacent prominent first printed markings 92, 92a, 92b, respectively, along the machine direction 102. As seen in FIG. 2, each prominent second printed marking 96, 96a, 96b is evenly spaced, e.g. spaced distance D₂, from an adjacent prominent second printed marking. The distance D₂ between adjacent prominent second printed markings is a function of the circumference of the second printing cylinder 44. However, the second prominent printed marking 96 is spaced distance D₃ from the first prominent printed marking 92, the second prominent printed marking 96a is spaced distance D₄ from the first prominent printed marking 92a, and the second prominent printed marking 96b is spaced D₅ from the first prominent printed marking 92b. This is due to the first printing cylinder 40 having a diameter d₁, which is different than the diameter of d₂ of the second printing cylinder 44. Moreover, the second printing cylinder 44 is not in register with the first printing cylinder 40, which results in the desirable unequal spacing between prominent second printing markings 96 and adjacent prominent first printing markings 92 along the machine direction 102 as the web 16 travels through the printing system 10. In other words, for a wood grain pattern the ring-shaped markings, the relatively tighter vertexes, and knots (not shown), denoted by the prominent first printed markings 92 and 104, will be equally spaced from other corresponding prominent first printed markings 92 and 104 along the machine direction 102. The space in between the prominent first printed markings 92, 104 and the ring-shaped markings, the relatively tighter vertexes, and knots (not shown) denoted by the second printed markings 96 and 96b, which are printed by the second printing cylinder 44, are unequally spaced due to the difference in the diameter between the first printing cylinder 40 and the second printing cylinder 44. The final print design on the web 16, therefore, provides a more random appearing print pattern, which results in a more natural wood grain appearance.

With reference back to FIG. 1, as mentioned above, the system 10 includes the first printing cylinder drive unit 70 for driving the first printing cylinder 40 at a first RPM. The system 10 also includes the second printing cylinder drive unit 74 for driving the second printing cylinder 44 at a second RPM, which is different than the first RPM. To reduce the amount of slack in the web 16 as the web travels through the system 10, the first RPM=the second RPM×(the first diameter/the second diameter). Each of these drive units 70 and 74 can also be equipped with or be in communication with a sensor to detect the tension of the web 16 as the web travels through the system 10 to run the drive units at the desired RPM to reduce the amount of slack in the system as the web 16 travels through the system.

The second print station 22, the fourth print station 26, and the fifth print station 28 apply color to the web 16 and can be referred to as color print stations. These respective printing cylinders 42, 46, 48 in the color print stations 22, 26, 28 can be referred to as color printing cylinders for applying a color to the web 16. The color printing cylinders 42 and 46 can apply a color print to the web that can add depth and highlight the print patterns applied at the first print station 20 and the third print station 24, respectively. This color, which adds depth to the final printed image, provides a more realistic and attractive printed design.

The first color printing cylinder 42 is disposed between the first printing cylinder 40 of the first print station 20 and the second printing cylinder 44 of the third print station 24 in the machine direction 102. As discussed above, a registration unit 80 can be interposed between the first print station 20 and the second print station 22. By including the registration unit 80, in the illustrated embodiment the first color printing cylinder 42 is in register with the first printing cylinder 40. In the illustrated embodiment, however, the second printing cylinder 44 is not in register with at least one of the first printing cylinder 40 and the first color printing cylinder 42. In the illustrated embodiment, the second printing cylinder 44 is not in register with each of the first printing cylinder 40 and the color printing cylinder 42. This can provide the advantage of making the repeat of the final printed pattern provided on the decorative sheet 12 further obfuscated to the ordinary observer. It may, however, be desirable to have the second printing cylinder 44 in register with the second color printing cylinder 46; therefore, an additional registration unit 82, which can communicate with the drive unit 76, can be provided.

With continued reference to FIG. 1, each color cylinder drive unit 72, 76, 78 is for driving the respective color printing cylinders. In the embodiment illustrated in FIG. 1, the color cylinder drive unit 72 for driving the color printing cylinder 42 drives the color printing cylinder 42 at substantially the same RPM as the first printing cylinder 40. Moreover, the first color printing cylinder 42 has a color printing cylinder diameter (d₁) that is the same as the diameter (d₁) of the first printing cylinder 40. These cylinders may be stepped, or increased in size, by about 0.0005″, however, for the purpose of this disclosure stepped cylinders within about 0.0005″ are referred to as having the same diameter.

In the illustrated embodiment, the first color printing cylinder 42 and the second printing cylinder 46 are each configured to apply a color print on the web 16 having knockouts that are devoid of color. The second print station 22 can also be configured to apply a color print on the web 16 in a manner such that the color print applied at the second print station 22 masks at least a portion of the second printed pattern, including the prominent second printed marking 96 and the other second printed markings 98, such that at least a portion of the second printed pattern is not visible after applying the second printed pattern. In other words, after the web 16 leaves the first print station 20, the prominent first printed mark 92 and the other first printed markings 94 have been applied to the web 16. At the second print station 22, the color print is applied that will mask later applied second printed markings, such as the printed markings 96 and 98 depicted in FIG. 2, even after these later printed markings have been applied at the third print station 24. This further obfuscates the repeated pattern of the prominent second printed markings 96 with respect to the first printed markings 92 making the final printed pattern on a decorative sheet 12 appear more random to an ordinary observer. Moreover, by providing knockouts, which are devoid of color, the final print pattern can appear even more random to an observer of an article, such as the article 90 (FIG. 2) having the final printed pattern applied thereto.

In the illustrated embodiment, the third print station 24 is not in register with at least one of the first print station 20 and the second print station 22 so that the space between the prominent first printed markings 92 with respect to the prominent second printed markings 96 appears even more unequal on the final printed pattern on the decorative sheet 12. Additionally, the fourth print station 26 is not in register with at least one of the first print station 20, the second print station 22, and the third print station 24, for the exemplary embodiment depicted in FIG. 1. For the depicted embodiment, the fourth print station 26 is not in register with each of the first print station 20 and the second print station 22. Additionally, the fourth print station 26 is not in register with the third print station 24, which further makes the prominent markings 92 and 96 appear even more random to the ordinary observer.

Similarly, the fifth print station 28 is not in register with at least one of the first print station 20, the second print station 22, the third print station 24, and the fourth print station 26. In the illustrated embodiment, the fifth print station is not in register with each of the first print station 20 and the second print station 22. Moreover, the fifth print station is not in register with the third print station 24 in the illustrated embodiment, and the fifth print station is not in register with the fourth print station 26 in the illustrated embodiment. This further makes the spacing between the prominent first printed markings 96 and the prominent second printed markings 98 even more unequal.

In FIG. 1, the first printing cylinder 40 and the first color printing cylinder 42 have the same diameter, d₁, and the remaining printing cylinders 44, 46, 48 have a different diameter d₂. Alternatively, the remaining printing cylinders 44, 46, 48 can each have a different diameter. The difference in diameters, e.g., the difference between d₁ and d₂, is great enough to result in the desirable unequal spacing between the prominent first printed markings 92, 92a, 92b and the prominent second printed markings 96, 96a, 96b. As such the difference in diameters between or among the printing cylinders can be greater than the stepped printing cylinders discussed above. For instance, d₁ can be at least about 5%-10% larger or smaller than d₂, d₁ can be at least about 3%-20% larger or smaller than d₂. Also, d₁ could be 1.5, 2, 2.5, 3 or even greater times larger or smaller than d₂.

A process for making the decorative sheet material 12 will now be described with further detail with reference to the system 10 depicted in FIG. 1. Generally, the process for making the decorative sheet material 12 includes applying a first printed pattern to the web 14 as the web travels over a first printing cylinder, such as the printing cylinder 40, having a first diameter d₁, and applying a second printed pattern to the web 16 as the web travels over a second printing cylinder, such as the printing cylinder 44, having a second diameter d₂ which is different than the first diameter. The first printed pattern and the second printed pattern can appear as one finished printed pattern on the decorative sheet material 12. Since two different printing cylinders having two different diameters are being used to manufacture the decorative sheet 12, the repeating nature of the final printed pattern on the decorative sheet material 12 is difficult to ascertain. When the printed pattern is meant to represent a natural looking material, such as a wood grain finish, the difficulty in ascertaining the repeating nature of the pattern provides a more authentic looking decorative sheet material.

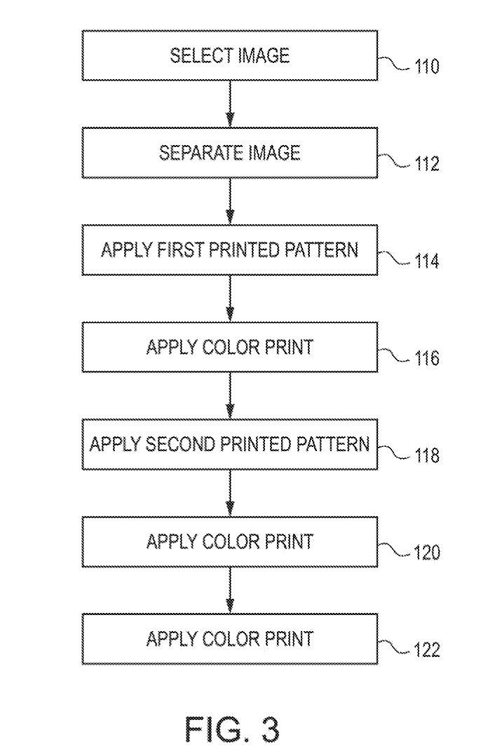

With reference to FIG. 3, the process for making a decorative sheet material can include selecting an image to be printed, at 110, and separating the image to be printed, at 112. The image can be separated into a first printed pattern, a second printed pattern, and a plurality of colors that are to be applied to the web. The process can further include applying the first printed pattern, at 114, to the web 16 (FIG. 1). The first and second printed patterns can simulate annual growth rings found in a natural wood grain pattern. The process can further include, at 116, applying a color print to the web. The process can further include applying the second printed pattern to the web, at 118, and applying color prints at 120 and 122. The color prints applied at 116 and 120 can provide depth to the final printed pattern to provide a more realistic final printed pattern, when the final printed pattern is attempting to imitate a natural printed pattern such as a wood grain finish.

At 110, the image that is to be printed is selected. The process for making a decorative sheet material that is described below has been found to be useful to print images onto a web where the repeating pattern of the image is difficult to detect. Examples of such images include wood grain patterns, however, other patterns where detection of the repeating nature of the pattern is difficult to ascertain could also be produced with the following process.

The selected image to be printed, which was selected at 110, is separated into different images at 112. Each different separated image can be applied to the web at a different printing station. For example, where the selected image that is to be printed is a wood grain printed pattern, the selected image can be separated into a first wood grain printed pattern, which can be printed at one printing station, and a second wood grain printed pattern, which can be printed at a second printing station, and color prints, which are also applied to the web at different printing stations, to produce the selected wood grain image.

At 114, the first printed pattern, among the separated images that were separated at 112, is applied to the web 16. With reference to the example pattern discussed above and shown in FIG. 2, applying the first printed pattern can include printing the first printed pattern on the web 16 to include at least one prominent first printed marking 92, 104 and other first printed markings 94, wherein the at least one prominent first printed marking is more prominent than the other first printed markings on the web 16. With regard to the system 10 described above, the first printed pattern can be applied to the web 16 at the first printing station 20.

The process for making the decorative sheet material 12 can further include, at 116, applying the color print to the web. When using the system 10 described above, the color print can be applied at the second printing station 22, which is immediately after the first printing station 20. The process can further include rotating the first printing cylinder 40 (FIG. 1) at a first RPM and rotating the color printing cylinder 42 in the second printing station 22 at the same RPM. As shown in FIG. 1, a registration unit 80 is disposed between the first printing station 20 and the second printing station 22. As such, the process can further include registering the web 16 between applying the first printed pattern and applying the color print. Because of the first printing station 20 and the second printing station 22 are in register, the color print that is applied at the second printing station is aligned with the first printed pattern applied at the first printing station 20. Applying the color print, at 116, can further include applying the color print in such a manner that the color print masks at least a portion of the second printed pattern, which is printed at 118, such that at least a portion of the second printed pattern is not visible on the web after applying the second printed pattern. Applying the color print, at 116, can also include applying the color print in a manner that the color print includes knockouts, which show up as areas on the web 16 that are devoid of the color being deposited on the web by the respective color printing cylinder.

With reference back to FIG. 3, the process further includes, as mentioned above, applying the second printed pattern at 118. For the system described above and depicted in FIG. 1, the second printed pattern is applied using the printing cylinder 44 at the third printing station 24. The second printing cylinder 44 has a smaller diameter than the first printing cylinder 40; however, the second printing cylinder 44 could have a larger diameter than the first printing cylinder 40. It is a difference in diameters that can result in the desirable obfuscation of the repeated pattern of the final printed image on the decorative sheet material 12. Applying the second printed pattern, at 118, further includes printing the second printed pattern on the web 16 to include at least one prominent second printed marking, such as the prominent printed markings 96, 106 (FIG. 2), and other second printed markings, such as the printed markings 98 (FIG. 2). The at least one prominent second printed marking 96, 106 is more prominent than the other second printed markings 98 on the web 16.

As mentioned above, the example shown in FIG. 2 is a wood grain pattern where each prominent marking 92, 104 and 96, 106 denotes a ring-shaped marking, a relatively tighter vertex or a knot in the wood grain. Applying the first printed pattern, at 114, results in equally spaced prominent first printed markings 92, 104 along the machine direction 102 of the web 16. By using a printing cylinder having a different diameter, applying the second printed pattern, at 118, results in unequal spacing between prominent second printed markings 96, 106 and adjacent first printed markings 92, 104 along the machine direction. With reference to FIG. 2, because the prominent first printed markings 92, 104 are applied using one printing cylinder rotating at a constant RPM, each prominent first printed marking 92, 104, respectively, is equally spaced along the machine direction 102. When utilizing the process described herein, each of the prominent second printed markings 96, 106, respectively, are also equally spaced from each other along the machine direction 102. However, since the diameter of the cylinder that is used to apply the prominent first printed markings 92, 104 is different than the diameter of the cylinder that is used to apply the prominent second printed markings 96, 106, the relative distance between prominent first printed markings and prominent second printed markings changes along the machine direction. Additionally, because the color print applied at the second printing station, at 116, can mask the second printed pattern applied at the third printing station 24, this further obfuscates the repeat of the wood grain pattern. This results in a final pattern on the decorative sheet 12 where the repeat identification of the pattern is difficult to ascertain.

Since the second printing cylinder 44 is different in diameter than the first printing cylinder 40, the process further includes rotating the second printing cylinder 44 at a second RPM, which is different than the first RPM, which is the RPM at which the first printing cylinder 40 rotates. To avoid slack in the web 16 as the web travels through the system 10, the first RPM=the second RPM×(the first diameter/the second diameter).

With continued reference to FIG. 3, applying the color print, at 116, can occur after applying the first printed pattern, at 114, and before applying the second printed pattern at 118. The second printed pattern is not in register with at least one of the first printed pattern and the color print applied at the second printing station 22. In the depicted embodiment, the second printed pattern is not in register with each of the first printed pattern and the color print applied at second printing station 22.

The process for making the decorative sheet material 12 can further include applying the color print at 120. With reference to the system 10 depicted in FIG. 1, this color print can be applied at the fourth printing station 26. The color print applied at 120 can be similar to the color print applied at 116. Applying each of the color prints, for example the color print at 116 and the color print at 120, can include applying the color print to include knock outs on the web 16 where no color is applied to the web. These knockouts can further obfuscate the repeated nature of the pattern since the second color print station, which is depicted as the fourth printing station 26 in FIG. 1, is not in register with the first printing station 20 and/or the second printing station 22. Applying the color prints, at 116, 120, and 122, can further include applying a first color print to the web, at 116, as the web travels over a first color printing cylinder, e.g. the printing cylinder 42; applying a second color print to the web, at 120, as the web 16 travels over a second color printing cylinder, such as printing cylinder 44; and applying a third color print to the web, at 122, as the web travels over a third color printing cylinder 48. The final color print, at 122, can apply a background color over at least substantially all of the web to provide the background color of the final desired image on the decorative sheet material 12.

In sum, the first printed pattern can be applied at the first printing station 20, the first color print can be applied at the second printing station 22, the second printed pattern can be applied at the third printing station 24, the second color print can be applied at the fourth printing 26 and the third color print can be applied at the fifth printing station 28, wherein each printing station is in consecutive order. If desired, however, the order in which the images are applied to the web can be altered. Moreover, many of the steps of the process have been described with reference to the system depicted in FIG. 1; however, the process could be performed on different systems.

A process to prevent identification of press repeat and a system to prevent the identification of the press repeat has been described above with particularity. Modifications and alterations will occur to those upon reading and understanding the preceding detailed description. The invention, however, is not limited to only the embodiments described above. Instead, the invention is broadly defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A process for making a decorative sheet material comprising:
applying a first printed pattern to a web as the web travels over a first printing cylinder having a first diameter;
applying a second printed pattern to the web as the web travels over a second printing cylinder having second diameter, which is different than the first diameter.

2. The process of claim 1, wherein
applying the first printed pattern includes printing the first printed pattern on the web to include at least one prominent first printed marking and other first printing marks, wherein the at least one prominent first printed marking is more prominent than the other first printed markings on the web; and
applying the second printed pattern includes printing the second printed pattern on the web to include at least one prominent second printed marking and other second printing marks, wherein the at least one prominent second printed marking is more prominent than the other second printed markings on the web.

3-5. (canceled)

6. The process of claim 1, further comprising:
rotating the first printing cylinder at a first RPM; and
rotating the second printing cylinder at second RPM, which is different than the first RPM.

7. (canceled)

8. The process of claim 1, further comprising:
separating an image to be printed into at least three images including the first printed pattern, the second printed pattern and a color print; and
applying the color print to the web as the web travels over a color printing cylinder.

9. The process of claim 8, wherein applying the color print occurs after applying the first printed pattern and before applying the second printed pattern.

10. (canceled)

11. The process of claim 8, wherein applying the color print further includes applying the color print in such a manner that the color print masks at least a portion of the second printed pattern such that at least a portion of the second printed pattern is not visible on the web after applying the second printed pattern.

12-14. (canceled)

15. The process of claim 8, wherein applying the color print to the web includes
applying a first color print to the web as the web travels over a first color print printing cylinder; and
applying a second color print to the web as the web travels over a second color printing cylinder.

16. The process of claim 15, further comprising applying a color coat to the web as the web travels over a color coat printing cylinder, wherein the first printed pattern is applied at a first print station, the first color print is applied at a second print station, the second printed pattern is applied at a third print station, the second color print is applied at a fourth print station, and the color coat is applied at a fifth print station, wherein each print station is in consecutive order.

17-21. (canceled)

22. A system for making a decorative sheet material, the system comprising:
a first printing cylinder for applying a first printed pattern on a web traveling over the first printing cylinder, wherein the first printing cylinder has a first diameter; and
a second printing cylinder for applying a second printed pattern on a web traveling over the second printing cylinder, wherein the second printing cylinder has a second diameter, which is different than the first diameter.

23. The system of claim 22, wherein the first printing cylinder is configured such that for each rotation the first printing cylinder prints the first printed pattern having at least one prominent first printed marking and other first printed markings, wherein the prominent first printed marking is more prominent than the other first printed markings on the web, wherein the second printing cylinder is configured such that for each rotation the second printing cylinder prints the second printed pattern having at least one prominent second printed marking and other second printed markings, wherein the prominent second printed marking is more prominent than the other second printed markings on the web.

24-25. (canceled)

26. The system of claim 22, wherein the first printing cylinder is configured to rotate to apply the first print pattern having equally spaced prominent first printed markings along a machine direction of the web, and the second printing cylinder is configured to rotate to apply the second printed pattern having unequal spacing between prominent second printed marks and adjacent prominent first printed markings along the machine direction.

27. The system of claim 22, further comprising
a first printing cylinder drive unit for driving the first printing cylinder at a first RPM; and
a second printing cylinder drive unit for driving the second printing cylinder at a second RPM, which is different than the first RPM.

28. (canceled)

29. The system of claim 22, further comprising a color printing cylinder for applying a color print to the web.

30-36. (canceled)

37. The system of claim 29, further comprising a first print station, a second print station and a third print station, wherein each print station is in consecutive order, wherein the first printing cylinder is located at the first print station, wherein the color printing cylinder is located at the second print station, and wherein the second printing cylinder is located at the third print station.

38-40. (canceled)

41. The system of claim 37, further comprising a fourth print station and a fifth print station, wherein each print station is in consecutive order, wherein the first color printing cylinder is located at the second print station, wherein the second color printing cylinder is located at the fourth print station, and wherein the third color print station is located at the fifth print station.

42-48. (canceled)

49. A decorative sheet material comprising:
a web;
a first printed pattern on the web including prominent first printed markings and other first printed markings, wherein each prominent first printed marking is evenly spaced from adjacent prominent first printed markings in a machine direction; and
a second printed pattern on the web including prominent second printed markings and other second printed markings, wherein each prominent second printed marking is unevenly spaced from adjacent prominent first printed markings in the machine direction.

50. The material of claim 49, wherein each printed pattern is a wood grain pattern.

51. The material of claim 49, wherein each prominent printed marking denotes a ring-shaped marking, a relatively tighter vertex or a knot in a natural wood grain.

52. The material of claim 49, further comprising at least one color print applied to the web.

53. (canceled)

54. The material of claim 52, wherein the at least one color print masks at least a portion of the second printed pattern in such that at least a portion of the second printed pattern is not visible on the web when the at least one color print and the second printed pattern have been applied to the web.

55-58. (canceled)
